(19) United States
(12) Patent Application Publication
(10) Pub. No.: US 2026/0349621 A1
(43) Pub. Date: Nov. 5, 2026

(54) COMPUTING CHIPLET AND ELECTRONIC DEVICE

(71) Applicant: Moore Threads Technology Co., Ltd., Beijing (CN)

(72) Inventors: Kun GAO, Beijing (CN); Si WEN, Beijing (CN); Xiaosen LI, Beijing (CN)

(21) Appl. No.: 19/721,337

(22) Filed: Jun. 26, 2026

Related U.S. Application Data
(63) Continuation of application No. PCT/CN2024/134081, filed on Nov. 25, 2024.

(30) Foreign Application Priority Data
Dec. 29, 2023 (CN) 202311865153.8

(51) Int. Cl. G06F 3/06

(52) U.S. Cl. CPC G06F 3/0655; G06F 3/0613; G06F 3/0679

(57) ABSTRACT

The present disclosure relates to a data processing method and apparatus, an electronic device, and a storage medium. The method includes: on the basis of tensor information of a first tensor and access information of a second tensor to be accessed, determining address information of said second tensor, and on the basis of the address information of said second tensor, reading said second tensor from a global memory storing the first tensor into a local memory; and in response to the local memory receiving said second tensor, triggering an interrupt. The embodiments of the present disclosure can improve the efficiency and flexibility of tensor storage, and each time the local memory receives the second tensor, an interrupt can be triggered, achieving asynchronization of the tensor reading process.

### CROSS-REFERENCE TO RELATED APPLICATION

The present application is based upon and claims the benefit of priority of Chinese Patent Application No. 202311865153.8 filed with the CNIPA on Dec. 29, 2023 and International Application No. PCT/CN2024/134081 filed on Nov. 25, 2024, the entire contents of which are incorporated herein by reference.

### TECHNICAL FIELD

The present disclosure relates to the technical field of computer technologies, and in particular, to a data processing method and apparatus, an electronic device, and a storage medium.

### BACKGROUND

With the continuous expansion of the application fields of artificial intelligence technology, requirements on aspects of performances of artificial intelligence chips are also becoming higher. As storage performance is one of the bottlenecks in the performance of artificial intelligence chips, it is desired to further improve the data flow design for artificial intelligence chips, so that artificial intelligence chips can access data with higher efficiency and flexibility.

### SUMMARY

The present disclosure provides a data processing technical solution.

According to an aspect of the present disclosure, a data processing method is provided. The method includes: determining, based on tensor information of a first tensor and access information of a second tensor to be accessed, address information of the second tensor; reading, based on the address information of the second tensor, the second tensor from a global memory storing the first tensor to a local memory; and triggering an interrupt in response to the local memory receiving the second tensor.

In a possible implementation, in a case where the second tensor to be accessed is a block data of the first tensor, the access information comprises: a position of the second tensor in the first tensor; and a size of the second tensor; determining, based on tensor information of a first tensor and access information of a second tensor to be accessed, address information of the second tensor, comprising: determining, based on the tensor information of the first tensor, the position of the second tensor in the first tensor, and the size of the second tensor, the address information of the second tensor from addresses of the first tensor.

In a possible implementation, the method further comprising: performing, based on the tensor information of the first tensor and the access information of the second tensor to be accessed, boundary checking on the second tensor, to obtain a checking result for the second tensor; and in a case where the checking result indicates that a first part of the second tensor is located inside the first tensor and a second part of the second tensor is located outside the first tensor, determining, based on the tensor information of the first tensor and the access information of the second tensor, address information of the first part of the second tensor, wherein the tensor information of the first tensor includes padding identifiers; reading, based on address information of the second tensor, the second tensor from a global memory storing the first tensor to a local memory, comprising: reading, based on the address information of the first part of the second tensor, the first part of the second tensor from the global memory storing the first tensor to the local memory; padding, based on the padding identifier, the second part of the second tensor, to obtain the second part of the second tensor; and writing the second part of the second tensor into the local memory.

In a possible implementation, in a case where the second tensor to be accessed is coverage data in the first tensor corresponding to any one or more elements in a convolution kernel, the access information comprises: an expanded matrix coordinate and a convolution kernel element coordinate, the expanded matrix being a matrix that is arranged in rows or columns by sequentially converting, in the first tensor, the coverage data corresponding to a receptive field of the convolution kernel into corresponding column vectors or row vectors based on description information; the description information comprising convolution description information and deconvolution description information; determining, based on tensor information of a first tensor and access information of a second tensor to be accessed, address information of the second tensor, comprising: obtaining a mapping relationship between the expanded matrix and the first tensor; and determining, based on the tensor information of the first tensor, the mapping relationship, the expanded matrix coordinate, and the convolution kernel element coordinate, the address information of the second tensor from addresses of the first tensor.

In a possible implementation, determining, based on the tensor information of the first tensor, the mapping relationship, the expanded matrix coordinate, and the convolution kernel element coordinate, the address information of the second tensor from addresses of the first tensor, comprising: determining, based on the expanded matrix coordinate and the convolution kernel element coordinate, the second tensor to be accessed from the expanded matrix; determining, based on the mapping relationship between the expanded matrix and the first tensor, a plurality of elements in the first tensor corresponding to the second tensor; and determining address information of the plurality of elements in the first tensor corresponding to the second tensor as the address information of the second tensor.

In a possible implementation, reading, based on address information of the second tensor, the second tensor from a global memory storing the first tensor to a local memory, comprising: in a case where the size of the second tensor is greater than a read bandwidth, based on the address information of the second tensor, splitting a first memory access request for reading the second tensor from the global memory to the local memory into a plurality of second memory access requests, wherein each second memory access request is used to read split data of a different part of the second tensor from the global memory to the local memory; and based on the plurality of second memory access requests, writing serially a plurality of split data in the global memory that constitute the second tensor into a local memory.

In a possible implementation, the tensor information of the first tensor is stored in the global memory and the access information of the second tensor to be accessed is stored in a register.

In a possible implementation, the first tensor comprises feature data in a deep learning task, and the feature data comprises at least one of image feature data, speech feature data, or text feature data.

According to an aspect of the present disclosure, a data processing apparatus is provided. The apparatus includes: a determining module, configured to determine, based on tensor information of a first tensor and access information of a second tensor to be accessed, address information of the second tensor; a reading module, configured to read, based on the address information of the second tensor, the second tensor from a global memory storing the first tensor to a local memory; and a trigger module, configured to trigger an interrupt in response to the local memory receiving the second tensor.

In a possible implementation, the determining module is configured to determine, in a case where the second tensor to be accessed is a block data of the first tensor, and the access information comprises a position of the second tensor in the first tensor and a size of the second tensor, the address information of the second tensor from addresses of the first tensor based on the tensor information of the first tensor, the position of the second tensor in the first tensor, and the size of the second tensor.

In a possible implementation, the determining module is further configured to: perform, based on the tensor information of the first tensor and the access information of the second tensor to be accessed, boundary checking on the second tensor, to obtain a checking result for the second tensor; and in a case where the checking result indicates that a first part of the second tensor is located inside the first tensor and a second part of the second tensor is located outside the first tensor, determine, based on the tensor information of the first tensor and the access information of the second tensor, address information of the first part of the second tensor; and the reading module is configured to read, in a case where the tensor information of the first tensor includes padding identifiers, the first part of the second tensor from a global memory storing the first tensor to a local memory based on address information of the first part of the second tensor; pad, based on the padding identifier, the second part of the second tensor, to obtain the second part of the second tensor; and write the second part of the second tensor into the local memory.

In a possible implementation, the determining module is configured to obtain, in a case where the second tensor to be accessed is coverage data in the first tensor corresponding to any one or more elements in a convolution kernel, and the access information comprises an expanded matrix coordinate and a convolution kernel element coordinate, a mapping relationship between the expanded matrix and the first tensor; and determine, based on the tensor information of the first tensor, the mapping relationship, the expanded matrix coordinate, and the convolution kernel element coordinate, address information of the second tensor from addresses of the first tensor, wherein the expanded matrix is a matrix that is arranged in rows or columns by sequentially converting, in the first tensor, the coverage data corresponding to a receptive field of the convolution kernel into corresponding column vectors or row vectors based on description information, the description information comprising convolution description information and deconvolution description information.

In a possible implementation, determining, based on the tensor information of the first tensor, the mapping relationship, the expanded matrix coordinate, and the convolution kernel element coordinate, the address information of the second tensor from addresses of the first tensor, comprising: determining, based on the expanded matrix coordinate and the convolution kernel element coordinate, the second tensor to be accessed from the expanded matrix; determining, based on the mapping relationship between the expanded matrix and the first tensor, a plurality of elements in the first tensor corresponding to the second tensor; and determining address information of the plurality of elements in the first tensor corresponding to the second tensor as the address information of the second tensor.

In a possible implementation, the reading module is configured to: split, in a case where the size of the second tensor is greater than a read bandwidth, a first memory access request for reading the second tensor from the global memory to the local memory into a plurality of second memory access requests based on address information of the second tensor, wherein each second memory access request is used to read split data of a different part of the second tensor from the global memory to the local memory; and based on the plurality of second memory access requests, write serially a plurality of split data in the global memory that constitute the second tensor into a local memory.

In a possible implementation, the tensor information of the first tensor is stored in the global memory and the access information of the second tensor to be accessed is stored in a register.

In a possible implementation, the first tensor comprises feature data in a deep learning task, and the feature data comprises at least one of image feature data, speech feature data, or text feature data.

According to an aspect of the present disclosure, an electronic device is provided. The electronic device includes: a processor; and a memory for storing instructions executable by the processor, wherein the processor is configured to invoke the instructions stored in the memory to execute the above method.

According to an aspect of the present disclosure, a computer readable storage medium having computer program instructions stored thereon is provided. The computer program instructions, when executed by a processor, implement the above method.

According to an aspect of the present disclosure, a computer program product comprising a computer readable code or a computer readable storage medium carrying the computer readable code is provided, wherein when the computer readable code runs in a processor of an electronic device, the processor of the electronic device carries out the methods described above.

In a possible implementation of the present disclosure, based on the tensor information of the first tensor and the access information of a second tensor to be accessed, the address information of the second tensor is determined; based on the address information of the second tensor, the second tensor is read from a global memory storing the first tensor to a local memory; and an interrupt is triggered in response to the local memory receiving the second tensor. In this way, based on the tensor information of the first tensor and the access information of the second tensor to be accessed, the second tensor may be quickly read from the global memory storing the first tensor to the local memory, improving the efficiency and flexibility of tensor storage. Further, one interrupt is triggered whenever the local memory receives the second tensor once, achieving asynchrony in a tensor reading process.

It is to be understood that both the foregoing general description and the following detailed description are exemplary and explanatory only and are not restrictive of the disclosure. Other features and aspects of the present disclosure will become apparent from the following detailed descriptions of exemplary embodiments with reference to the accompanying drawings.

### BRIEF DESCRIPTION OF THE DRAWINGS

The accompanying drawings, which are incorporated in and constitute a part of this specification, illustrate embodiments consistent with the present disclosure and, together with the description, serve to explain the technical solutions of the present disclosure.

FIG. 1 shows a flowchart of a data processing method according to an embodiment of the present disclosure.

FIG. 2 shows a schematic diagram of the hardware architecture according to an embodiment of the present disclosure.

FIG. 3 shows a schematic diagram of determination on the address information of the second tensor according to an embodiment of the present disclosure.

FIG. 4 shows a schematic diagram of another determination on the address information of the second tensor according to an embodiment of the present disclosure.

FIG. 5 shows a schematic diagram of the mapping relationship between the first tensor and the expanded matrix according to an embodiment of the present disclosure.

FIG. 6 shows a block diagram of a data processing apparatus according to an embodiment of the present disclosure.

FIG. 7 shows a block diagram of an electronic device according to an embodiment of the present disclosure.

### DETAILED DESCRIPTION

Various exemplary embodiments, features, and aspects of the present disclosure will be described in detail below with reference to the drawings. In the drawings, the same numerical references denote elements with the same or similar functions. Although various aspects of the embodiments are shown in the drawings, unless otherwise specified, the drawings are not necessarily drawn to scale.

The word “exemplary” used exclusively here means “serving as an example, embodiment or illustration”. Any embodiment described here as “exemplary” is not necessarily to be interpreted as superior to or better than other embodiments.

The term “and/or” in this specification is merely an association relationship for describing associated objects, and represents that three relationships may exist, for example, A and/or B may represent three cases: A exists alone, both A and B exist, and B exists alone. In addition, the term “at least one” herein represents any one of a plurality or any combination of at least two of a plurality, for example, comprising at least one of A, B, or C may represent comprising any one or more elements selected from a set consisting of A, B, and C.

In addition, to better describe the present disclosure, numerous specific details are given in the following specific embodiments. It is appreciated by those skilled in the art that the present disclosure can still be implemented without some specific details. In some embodiments, methods, means, elements, and circuits well known to those skilled in the art are not described in detail in order to highlight the gist of the present disclosure.

With the widespread application of deep learning and neural networks, data is often stored in a form of tensor, which can extend vectors and matrices to an arbitrary number of dimensions. In the related art, a processor (for example, including a General-Purpose Computing on Graphics Processing Units (GPGPU)) accesses a storage space in which a tensor is stored. The storage space needs to be decomposed; each thread of the processor accesses a part of it; and during the access by each thread to a part of the storage space that it is responsible for, a large amount of address calculation instructions and boundary checking instructions also need to be added. This approach for accessing tensor storage space has low efficiency. Meanwhile, because there may be a limit on space size for a single instruction accessing the storage space, it is necessary to use multiple instructions in cooperation for accessing a tensor occupying a relatively large amount of storage space. This is not flexible enough in use and also affects improvement of memory access performance.

In view of this, in order to improve the efficiency and flexibility of tensor storage, an embodiment of the present disclosure provides a data processing method. FIG. 1 shows a flowchart of a data processing method according to an embodiment of the present disclosure. As shown in FIG. 1, the data processing method includes:

In step S11, determining, based on tensor information of a first tensor and access information of a second tensor to be accessed, address information of the second tensor;

In step S12, reading, based on the address information of the second tensor, the second tensor from a global memory storing the first tensor to a local memory; and

In step S13, triggering an interrupt in response to the local memory receiving the second tensor.

In the data processing method according to the embodiment of the present disclosure, based on tensor information of the first tensor and access information of the second tensor to be accessed, the second tensor may be quickly read from the global memory storing the first tensor to the local memory, improving the efficiency and flexibility of tensor storage. Further, one interrupt is triggered whenever the local memory receives the second tensor once, achieving asynchrony in a tensor reading process.

In a possible implementation, the data processing method according to the embodiment of the present disclosure may be executed by a tensor storage engine. The tensor storage engine is a hardware module in a processor chip for implementing data migration. The processor chip may be newly designed or obtained after modification on an existing processor chip. Types of the processor chip may include but are not limited to: a Central Processing Unit (CPU), a Graphic Processing Unit (GPU), a General-Purpose Computing on Graphics Processing Units (GPGPU), a Digital Signal Processor (DSP), an Application Specific Integrated Circuit (ASIC), a Tensor Processing Unit (TPU), a Field Programmable Gate Array (FPGA), or another programmable logic device, and may further include a processor of microprocessor or another conventional processor.

In a possible implementation, the processor chip may include one or more tensor storage engines. The present disclosure does not limit the number of tensor storage engines in the processor chip.

In an example, for a single-core single-thread processor chip, one tensor storage engine may be provided in the processor chip, to perform data migration processing on a first tensor stored in a global memory outside the processor chip, and store a second tensor determined based on the first tensor into a local memory corresponding to the tensor storage engine within the processor chip.

In an example, for a multi-core multi-thread processor chip, multiple tensor storage engines may be provided in the processor chip. For example, assuming that the processor chip includes N (N≥2) computing cores, and each computing core can execute M (M≥2) threads in parallel, then one tensor storage engine may be provided for each computing core. The M threads in each computing core may share one tensor storage engine and a local memory. The tensor storage engine is used to perform data migration processing on a first tensor stored in a global memory shared by multiple computing cores, and store a second tensor determined based on the first tensor into a local memory within the computing core. Alternatively, M tensor storage engines may be provided for each computing core; each thread in each computing core may correspond to one tensor storage engine and one local memory. The tensor storage engine is used to perform data migration processing on a first tensor stored in a global memory shared by multiple computing cores, and store a second tensor determined based on the first tensor into a local memory corresponding to the tensor storage engine within the computing core.

In an example, for a multi-core single-thread processor chip, multiple tensor storage engines may be provided in the processor chip. For example, assuming that the processor chip includes N (N≥2) single-threaded computing cores, then one tensor storage engine may be provided for each computing core. The tensor storage engine is used to perform data migration processing on a first tensor stored in a global memory shared by multiple computing cores, and store a second tensor determined based on the first tensor into a local memory within the computing core.

In an example, for a single-core multi-thread processor chip, multiple tensor storage engines may be provided in the processor chip. For example, assuming that the processor chip can execute M (M≥2) threads in parallel, then each thread may correspond to one tensor storage engine and one local memory. Each tensor storage engine may be used to perform data migration processing on a first tensor stored in a global memory shared by multiple threads, and store a second tensor determined based on the first tensor into a local memory corresponding to the tensor storage engine.

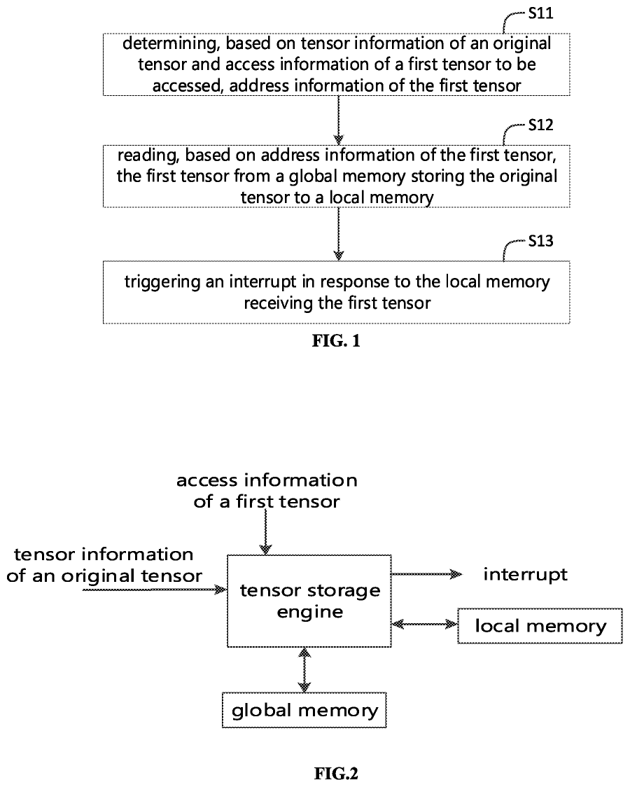

In a possible implementation, FIG. 2 shows a schematic diagram of the hardware architecture according to an embodiment of the present disclosure. As shown in FIG. 2, a tensor storage engine is connected with a global memory and a local memory respectively, and may be used to perform read operations and/or write operations on the global memory and the local memory. Moreover, the tensor storage engine may be further used to receive the tensor information of a first tensor and the access information of a second tensor, so as to migrate the second tensor from the global memory storing the first tensor to the local memory, and trigger an interrupt in response to the local memory receiving the second tensor.

An exemplary description is given below on a tensor storage engine implementing the data processing method according to an embodiment of the present disclosure.

In step S11, determining, based on the tensor information of a first tensor and the access information of a second tensor to be accessed, address information of the second tensor.

In a possible implementation, the first tensor is a multi-dimensional tensor and may be regarded as a multi-dimensional matrix. For example, the first tensor may be a two-dimensional tensor, a three-dimensional tensor, a four-dimensional tensor, or a tensor data of other more dimensions. The embodiments of the present application do not limit the number of dimensions of the first tensor.

In a possible implementation, the first tensor comprises feature data in a deep learning task, and the feature data comprises at least one of image feature data, speech feature data, or text feature data.

For example, in a scenario of face recognition on a target object using a deep neural network, the first tensor may be image feature data. The image feature data of the target object (for example, a face feature map) may be stored in the global memory. In a scenario of speech recognition on a target object using a deep neural network, the first tensor may be speech feature data. The speech feature data of the target object may be stored in the global memory. In a scenario of text recognition on a target document using a deep neural network, the first tensor may be text feature data. The text feature data of the target document may be stored in the global memory. The embodiments of the present application do not limit the type of the first tensor.

In a possible implementation, the tensor information of the first tensor may include data structure information of the first tensor and address information of the first tensor. The data structure information of the first tensor includes, for example, information used to describe the first tensor, such as a dimension of the first tensor, a size of the first tensor, and a data type (for example, an integer type, a single precision floating point number type, a double precision floating point number type, a character type, and the likes) of elements in the first tensor. The address information of the first tensor includes, for example, information related to an address, such as a base address, an addressing space, and the likes, of the first tensor in a global memory.

The tensor information of the first tensor includes a large amount of content, therefore the tensor information of the first tensor may be stored in the global memory.

In a possible implementation, in the case where the second tensor to be accessed is a block data of the first tensor, the access information comprises: a position of the second tensor in the first tensor; and a size of the second tensor. The step S11 may include: determining, based on the tensor information of the first tensor, the position of the second tensor in the first tensor, and the size of the second tensor, the address information of the second tensor from addresses of the first tensor.

For example, FIG. 3 shows a schematic diagram of determination on the address information of the second tensor according to an embodiment of the present disclosure. As shown in FIG. 3, the second tensor “block” to be accessed is a block data of the first tensor “tensor”, and the second tensor “block” may be data within any local region of the first tensor “tensor”.

The first tensor “tensor” is a two-dimensional tensor, and the tensor information of the first tensor “tensor” includes: a base address “tensor_base_address” for determining a storage position for the first tensor “tensor” in the global memory, a size in horizontal dimension “tensor_dim[0]” of the first tensor “tensor”, and a size in vertical dimension “tensor_dim[1]” of the first tensor “tensor”. The first tensor “tensor” is of continuous addresses in the lowest dimension (for example, the horizontal dimension or the vertical dimension), so the tensor storage engine may access each element in the first tensor “tensor” based on the base address “tensor_base_address” of the first tensor “tensor” and the position of each element in the first tensor “tensor”.

As shown in FIG. 3, the access information of the second tensor “block” includes: a position “block_pos” of the second tensor “block” in the first tensor “tensor”, a size in horizontal dimension “block_dim[0]” of the second tensor “block”, and a size in vertical dimension “block_dim[1]” of the second tensor “block”

The tensor storage engine may determine the base address “block_base_address” of the second tensor “block” based on the base address “tensor_base_address” in the tensor information of the first tensor “tensor” and the position “block_pos” of the second tensor “block” in the first tensor “tensor”.

The tensor storage engine may determine that a size of addressing space of the second tensor “block” is block_dim[0]×block_dim[1], based on the size in horizontal dimension “block_dim[0]” of the second tensor “block” and a size in vertical dimension “block_dim[1]” of the second tensor “block”.

The tensor storage engine may determine the address information of the second tensor “block” to be accessed in the global memory, based on the base address “block_base_address” of the second tensor “block” and the size of addressing space “block_dim[0]×block_dim[1]” of the second tensor “block”.

In this way, based on the tensor information of the first tensor and the access information of a second tensor to be accessed, the tensor storage engine may quickly and accurately determine the address information of the second tensor (for example, any block data in the first tensor) from addresses of the first tensor.

In a case where the second tensor to be accessed is a block data at an edge of the first tensor, there may be a case that data in a partial region of the second tensor does not fall within the first tensor. In a possible implementation, the method further includes: firstly, performing, based on the tensor information of the first tensor and the access information of the second tensor to be accessed, boundary checking on the second tensor, to obtain a checking result for the second tensor, wherein the checking result is used to determine whether the second tensor is located inside the first tensor; and in a case where the checking result indicates that a first part of the second tensor is located inside the first tensor and a second part of the second tensor is located outside the first tensor, determining, based on the tensor information of the first tensor and the access information of the second tensor to be accessed, address information of the first part of the second tensor.

The tensor information of the first tensor further includes padding identifiers (for example, numeral 0, numeral 1, etc.). The tensor storage engine may pad the second part of the second tensor based on the padding identifier to obtain the second part of the second tensor; so that, so as to in the subsequent step S12, in addition to reading the first part of the second tensor from the global memory storing the first tensor to the local memory based on the address information of the first part of the second tensor, the second part of the second tensor is also synchronously written into the local memory, enabling the local memory to store a complete second tensor.

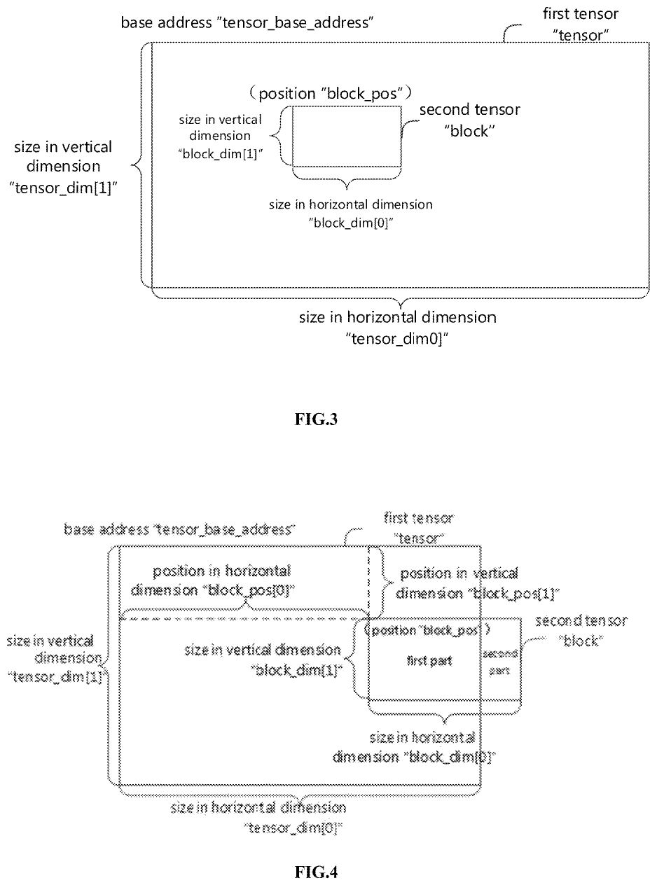

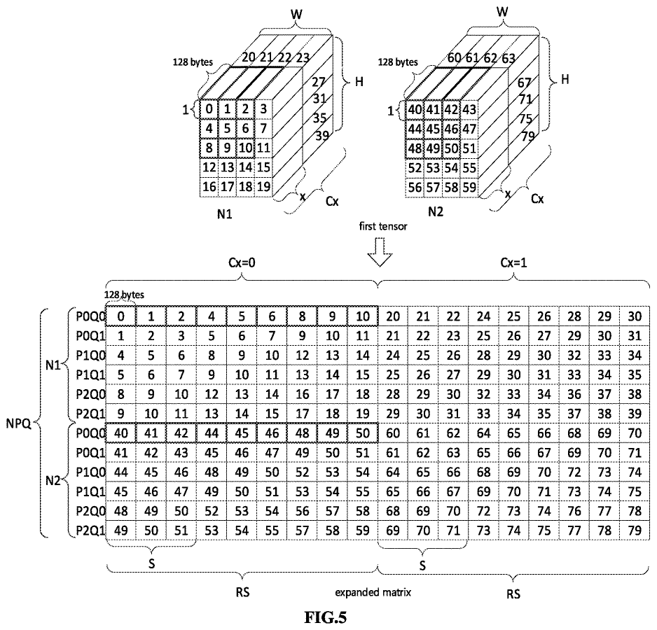

FIG. 4 shows a schematic diagram of a determination on the address information of a first part of the second tensor according to an embodiment of the present disclosure. As shown in FIG. 4, the tensor information of the first tensor “tensor” includes: a base address “tensor_base_address” for determining a storage position of the first tensor “tensor” in the global memory, a size in horizontal dimension “tensor_dim[0]” of the first tensor “tensor”, and a size in vertical dimension “tensor_dim[1]” of the first tensor “tensor”. The access information of the second tensor “block” includes: a position “block_pos” of the second tensor “block” in the first tensor “tensor”, a size in horizontal dimension “block_dim[0]” of the second tensor “block”, and a size in vertical dimension “block_dim[1]” of the second tensor “block”. The position “block_pos” of the second tensor “block” in the first tensor “tensor” includes: a position in horizontal dimension “block_pos[0]” of the second tensor “block” in the first tensor “tensor”, and a position in vertical dimension “block_pos[1]” of the second tensor “block” in the first tensor “tensor”.

A checking result for the second tensor “block” may be obtained first based on the tensor information of the first tensor “tensor” and the access information of the second tensor “block” to be accessed. The checking result is used for determining whether the second tensor “block” is located inside the first tensor “tensor”.

If a result of adding the position in horizontal dimension “block_pos[0]” of the second tensor “block” in the first tensor “tensor” and the size in horizontal dimension “block_dim[0]” of the second tensor “block” is less than or equal to the size in horizontal dimension “tensor_dim[0]” of the first tensor “tensor”, that is: (block_pos[0]+block_dim[0])≤tensor_dim[0], and a result of adding the position in vertical dimension “block_pos[1]” of the second tensor “block” in the first tensor “tensor” and the size in vertical dimension “block_dim[1]” of the second tensor “block” is less than or equal to the size in vertical dimension “tensor_dim[1]” of the first tensor “tensor”, that is: (block_pos[1]+block_dim[1])≤tensor_dim[1], it may be determined that the second tensor “block” is located inside the first tensor “tensor”. The address information of the second tensor “block” may be determined by referring to the above manner shown by FIG. 3, which will not be redundantly described herein.

If a result of adding the position in horizontal dimension “block_pos[0]” of the second tensor “block” in the first tensor “tensor” and the size in horizontal dimension “block_dim[0]” of the second tensor “block” is greater than the size in horizontal dimension “tensor_dim[0]” of the first tensor “tensor”, that is: (block_pos[0]+block_dim[0])>tensor_dim[0], and/or, if a result of adding the position in vertical dimension “block_pos[1]” of the second tensor “block” in the first tensor “tensor” and the size in vertical dimension “block_dim[1]” of the second tensor “block” is greater than the size in vertical dimension “tensor_dim[1]” of the first tensor “tensor”, that is: (block_pos[1]+block_dim[1])>tensor_dim[1], it may be determined that there is data in a partial region of the second tensor “block” not falling within the first tensor “tensor”. As shown in FIG. 4, a first part of the second tensor “block” to be accessed is located inside the first tensor “tensor”, and a second part of the second tensor “block” is located outside the first tensor “tensor”.

In a case where the first part of the second tensor “block” is located inside the first tensor “tensor” and the second part of the second tensor “block” is located outside the first tensor “tensor”, the tensor storage engine may determine the address information of the first part of the second tensor “block” based on the tensor information of the first tensor “tensor” and the access information of the second tensor “block” to be accessed.

In an example, the tensor storage engine may determine the base address “block_base_address” of the second tensor “block”, that is, the base address “block_base_address” of the first part of the second tensor “block”, based on the base address “tensor_base_address” in the tensor information of the first tensor “tensor” and the position “block_pos” of the second tensor “block” in the first tensor “tensor”.

Optionally, in a case where (block_pos[0]+block_dim[0])>tensor_dim[0] and (block_pos[1]+block_dim[1])>tensor_dim[1], the tensor storage engine may determine a size of addressing space of the first part of the second tensor “block”, which is (tensor_dim[0]−block_pos[0])×(tensor_dim[1]−block_pos[1]), based on the size in horizontal dimension “tensor_dim[0]” of the first tensor “tensor”, the size in vertical dimension “tensor_dim[1]” of the first tensor “tensor”, the position in horizontal dimension “block_pos[0]” of the second tensor “block” in the first tensor “tensor”, and the position in vertical dimension “block_pos[1]” of the second tensor “block” in the first tensor “tensor”.

The tensor storage engine may determine the address information of the first part of the second tensor “block” to be accessed in the global memory based on the base address “block_base_address” of the second tensor “block” and the size of addressing space of the first part of the second tensor “block”, (tensor_dim[0]−block_pos[0])×(tensor_dim[1]−block_pos[1]).

Optionally, in a case where (block_pos[0]+block_dim[0])>tensor_dim[0] and (block_pos[1]+block_dim[1])≤tensor_dim[1] (see FIG. 4), the tensor storage engine may determine a size of addressing space size of the first part of the second tensor “block”, which is (tensor_dim[0]−block_pos[0])×block_dim[1], based on the size in horizontal dimension “tensor_dim[0]” of the first tensor “tensor”, the position in horizontal dimension “block_pos[0]” of the second tensor “block” in the first tensor “tensor”, and the size in vertical dimension “block_dim[1]” of the second tensor “block”.

The tensor storage engine may determine the address information of the first part of the second tensor “block” to be accessed in the global memory based on the base address “block_base_address” of the second tensor “block” and the size of addressing space of the first part of the second tensor “block” (tensor_dim[0]−block_pos[0])×block_dim[1].

Optionally, in a case where (block_pos[0]+block_dim[0])≤tensor_dim[0] and (block_pos[1]+block_dim[1])>tensor_dim[1], the tensor storage engine may determine a size of addressing space of the first part of the second tensor “block”, which is block_dim[0]×(tensor_dim[1]−block_pos[1]), based on the size in vertical dimension “tensor_dim[1]” of the first tensor “tensor”, the position in vertical dimension “block_pos[1]” of the second tensor “block” in the first tensor “tensor”, and the size in horizontal dimension “block_dim[0]” of the second tensor “block”.

The tensor storage engine may determine the address information of the first part of the second tensor “block” to be accessed in the global memory based on the base address “block_base_address” of the second tensor “block” and the size of addressing space size of the first part of the second tensor “block”, which is block_dim[0]×(tensor_dim[1]−block_pos[1]).

The tensor information of the first tensor “tensor” further includes padding identifiers (for example, numeral 0, numeral 1, etc.). The tensor storage engine may pad the second part of the second tensor “block” based on to the padding identifier to obtain the second part of the second tensor, so that in subsequent step S12, in addition to reading the first part of the second tensor “block” from the global memory storing the first tensor “tensor” to the local memory based on the address information of the first part of the second tensor “block”, the padded second part of the padded second tensor “block” is also synchronously written into the local memory, enabling the local memory to store a complete second tensor “block”.

In this way, the address information of the second tensor may be determined from addresses of the first tensor based on the tensor information of the first tensor, a position of the second tensor in the first tensor, and a size of the second tensor. The second tensor may be a block data obtained by cutting the first tensor by any size, facilitating the tensor storage engine subsequently accessing, with single instruction, any block data in the first tensor which occupies a relatively large space from the global memory, improving the applicability of the data processing method according to embodiments of the present disclosure. Moreover, the tensor storage engine may further implement automatic address calculation and boundary checking on block data, while implementing a padding process with any constant value for out-of-bound access.

In a possible implementation, the convolution kernel may traverse the entire first tensor by sliding on the first tensor. To facilitate the convolution operation and/or deconvolution operation on the first tensor and to further improve the applicability of the data processing method according to embodiments of the present disclosure, in the case where the second tensor to be accessed is coverage data in the first tensor corresponding to any one or more elements in a convolution kernel, the access information comprises: an expanded matrix coordinate and a convolution kernel element coordinate, the expanded matrix being a matrix that is arranged in rows or columns by sequentially converting, in the first tensor, the coverage data corresponding to a receptive field of the convolution kernel into corresponding column vectors or row vectors based on description information; the description information comprising convolution description information and deconvolution description information. Step S11 may include: obtaining a mapping relationship between the expanded matrix and the first tensor; and determining, based on the tensor information of the first tensor, the mapping relationship, the expanded matrix coordinate, and the convolution kernel element coordinate, the address information of the second tensor from addresses of the first tensor.

The tensor information of the first tensor may include data structure information of the first tensor (for example, including a dimension of the first tensor, a size of the first tensor, a data type of elements in the first tensor, etc.) and address information of the first tensor (for example, including a base address and an addressing space of the first tensor in the global memory, etc.). The mapping relationship is used to determine address information of each element of the expanded matrix in a global storage space. The expanded matrix coordinate and the convolution kernel element coordinate are used for positioning the second tensor in the expanded matrix.

The description information is used to provide an expanding approach for expanding an original matrix into an expanded matrix suitable for convolution kernel. The description information includes a size of the convolution kernel, a stride of the convolution kernel, a padding amount, a dilation rate, and the likes. If the description information is deconvolution description information and a stride in the deconvolution description information is greater than 1, during a process of converting coverage data corresponding to a receptive field of a convolution kernel into a corresponding column vector or row vector and arranging them in rows and columns in the expanded matrix, constant value padding operations may be performed between individual elements of the coverage data based on padding identifiers (for example, numeral 0, numeral 1 etc.) included in the tensor information of the first tensor.

FIG. 5 shows a schematic diagram of the mapping relationship between the first tensor and the expanded matrix according to an embodiment of the present disclosure. As shown in FIG. 5, the tensor storage engine may know, based on the obtained tensor information of first tensor, that the first tensor is a four-dimensional tensor N×Cx×H×W (see two cuboids on the upper side of FIG. 5, whose size sis 2×2×5×4), where N represents a dimension in which the batch is located, Cx represents a dimension in which the channel is located, H represents a dimension in which the height is located, and W represents a dimension in which the width is located.

As shown in FIG. 5, the numerical marks 0-79 in the first tensor are used to distinguish elements of the first tensor, each element occupying a storage space of 128 bytes (80HB in hexadecimal notation) in the global memory. In this way, assuming that the base address of the first tensor in the global memory is “address”, the address information of element 0 of the first tensor in the global memory is address~(address+007FH), the address information of element 1 of the first tensor in the global memory is (address+0080H)~(address+00FFH), the address information of element 2 of the first tensor in the global memory is (address+0100H)~(address+017FH), and so on; the address information of element 79 of the first tensor in the global memory is (address+2780H)~(address+27FFH).

The two-dimensional matrix shown on the lower side of FIG. 5 is the expanded matrix of the first tensor; the expanded matrix is a two-dimensional matrix arranged in rows or columns sequentially converting, in the first tensor and by an order of convolution kernel sliding, the coverage data corresponding to a receptive field of a convolution kernel into corresponding row vectors, based on the convolution description information (for example, a size of the convolution kernel is 3×3, a stride of the convolution kernel is 1, and a padding amount is 0).

As shown in FIG. 5, it is assumed that P represents a position where the convolution kernel slides in the height direction, Q represents a position where the convolution kernel slides in the width direction, Cx represents a position where the convolution kernel slides in the channel direction, and N represents whether the convolution kernel slides in a part “N1×Cx×H×W” of the first tensor or a part “N2×Cx×H×W” of the first tensor.

As shown in FIG. 5, in a first time the convolution kernel slides to a position Q0 in width direction, slides to a position P0 in height direction, and slides to a position Cx=0 in channel direction. The coverage data corresponding to the receptive field of the convolution kernel in the part “N1×Cx×H×W” of the first tensor is

$$[ \begin{matrix}0 & 1 & 2 & 4 & 5 & 6 & 8 & 9 & 10\end{matrix} ] ⌈ \begin{matrix}0 & 1 & 2 \\ 4 & 5 & 6\end{matrix} ⌉ ,$$

which may be converted into [0 1 2 4 5 6 8 9 10]. The coverage data corresponding to the receptive field of the kernel in the part “N2×Cx×H×W” of the first tensor is convolution

$$[ \begin{matrix}40 & 41 & 42 & 44 & 45 & 46 & 48 & 49 & 50\end{matrix} ] ⌈ \begin{matrix}40 & 41 & 42 \\ 44 & 45 & 46\end{matrix} ⌉ ,$$

which may be converted into [40 41 42 44 45 46 48 49 50].

In a second time, the convolution kernel slides to a position Q1 in width direction, remains at a position P0 in height direction, and slides to a position Cx=0 in channel direction. The coverage data corresponding to the receptive field of the convolution kernel in the part “N1×Cx×H×W” of the first tensor is

$$[ \begin{matrix}1 & 2 & 3 & 5 & 6 & 7 & 9 & 10 & 11\end{matrix} ] ⌊ \begin{matrix}1 & 2 & 3 \\ 5 & 6 & 7\end{matrix} ⌉ ,$$

which may be converted into [1 2 3 5 6 7 9 10 11]. The coverage data corresponding to the receptive field of the convolution kernel in the part “N2×Cx×H×W” of the first tensor is

$$[ \begin{matrix}41 & 42 & 43 & 45 & 46 & 47 & 49 & 50 & 51\end{matrix} ] ⌈ \begin{matrix}41 & 42 & 43 \\ 45 & 46 & 47\end{matrix} ⌉ ,$$

which may be converted into [41 42 43 45 46 47 49 50 51].

In a third time the convolution kernel slides to a position Q0 in width direction, remains at a position P1 in height direction, and slides to position Cx=0 in channel direction. The coverage data corresponding to the receptive field of the convolution kernel in the part “N1×Cx×H×W” of the first tensor is

$$[ \begin{matrix}4 & 5 & 6 & 8 & 9 & 10 & 12 & 13 & 14\end{matrix} ] ⌈ \begin{matrix}4 & 5 & 6 \\ 8 & 9 & 10\end{matrix} ⌉ ,$$

which may be converted into [4 5 6 8 9 10 12 13 14]. The coverage data corresponding to the receptive field of the convolution kernel in the part “N2×Cx×H×W” of the first tensor is

$$[ \begin{matrix}44 & 45 & 46 & 48 & 49 & 50 & 52 & 53 & 54\end{matrix} ] ⌈ \begin{matrix}44 & 45 & 46 \\ 48 & 49 & 50\end{matrix} ⌉ ,$$

which may be converted into [44 45 46 48 49 50 52 53 54].

In this way, until a twelfth time, the convolution kernel slides to a position Q1 in width direction, slides to a position P2 in height direction, and slides to a position Cx=1 in channel direction. The coverage data corresponding to the receptive field of the convolution kernel in the part “N1×Cx×H×W” of the first tensor is

$$[ \begin{matrix}29 & 30 & 31 & 33 & 34 & 35 & 37 & 38 & 39\end{matrix} ] ⌈ \begin{matrix}29 & 30 & 31 \\ 33 & 34 & 35\end{matrix} ⌉ ,$$

which may be converted into [29 30 31 33 34 35 37 38 39]. The coverage data corresponding to the receptive field of the convolution kernel in the part “N2×Cx×H×W” of the first tensor is

$$[ \begin{matrix}69 & 70 & 71 & 73 & 74 & 75 & 77 & 78 & 79\end{matrix} ] ⌈ \begin{matrix}69 & 70 & 71 \\ 73 & 74 & 75\end{matrix} ⌉ ,$$

which may be converted into [69 70 71 73 74 75 77 78 79].

The row vectors after the 12 times of coverage data conversion are arranged in rows or columns to obtain an expanded matrix as shown in FIG. 5. The mapping relationship between the expanded matrix and the first tensor may be obtained based on the correspondences between elements having the same numeral marks in the first tensor and the expanded matrix. In an example, the tensor storage engine may directly obtain the mapping relationship between the expanded matrix and the first tensor input by the user. Alternatively, the tensor storage engine may first perform, based on the obtained tensor information of the first tensor and the description information, the foregoing expanding processing on the first tensor read from the global memory, to determine the expanded matrix, and then obtain, based on the correspondence between the first tensor and the expanded matrix, the mapping relationship between the expanded matrix and the first tensor.

It should be understood that FIG. 5 shows a case in which the description information is convolution description information. If the description information is deconvolution description information, by referring to the foregoing introduction, in a case where a stride of a convolution kernel in the deconvolution description information is greater than 1, constant value padding operations may be performed between individual elements in the expanded matrix, which will not be redundantly described herein.

In a possible implementation, determining, based on the tensor information of the first tensor, the mapping relationship, the expanded matrix coordinate, and the convolution kernel element coordinate, the address information of the second tensor from addresses of the first tensor, comprising: determining, based on the expanded matrix coordinate and the convolution kernel element coordinate, the second tensor to be accessed from the expanded matrix; determining, based on the mapping relationship between the expanded matrix and the first tensor, a plurality of elements in the first tensor corresponding to the second tensor; and determining address information of the plurality of elements in the first tensor corresponding to the second tensor as address information of the second tensor.

In the expanded matrix shown in FIG. 5, NPQ may be taken as a coordinate in vertical dimension of the expanded matrix to locate a certain row in the expanded matrix. For example, N1P0Q0 represents the first row; N1P0Q1 represents the second row; N1P1Q0 represents the third row; N1P1Q1 represents the fourth row; N1P2Q0 represents the fifth row; N1P2Q1 represents the sixth row; N2P0Q0 represents the seventh row; N2P0Q1 represents the eighth row; N2P1Q0 represents the ninth row; N2P1Q1 represents the tenth row; N2P2Q0 represents the eleventh row; and N2P2Q1 represents the twelfth row.

The Cx can be taken as a coordinate in horizontal dimension of the expanded matrix, Cx=0 can be used to locate 8 columns on the left side of the expanded matrix, and Cx=1 can be used to locate 8 columns on the right side of the expanded matrix.

RS are coordinates of the convolution kernel element, R represents a coordinate in vertical dimension of the convolution kernel and is used to locate a certain row of the convolution kernel, S represents a coordinate in horizontal dimension of the convolution kernel and is used to locate a certain column of the convolution kernel. For example, R=0 and S=0 represent a convolution kernel element in the first row and the first column, R=0 and S=1 represent a convolution kernel element in the first row and the second column, R=0 and S=2 represent a convolution kernel element in the first row and the third column, R=1 and S=0 represent a convolution kernel element in the second row and the first column, R=1 and S=1 represent a convolution kernel element in the second row and the second column, R=1 and S=2 represent a convolution kernel element in the second row and the third column, R=2 and S=0 represent a convolution kernel element in the third row and the first column, R=2 and S=1 represent a convolution kernel element in the third row and the second column, and R=2 and S=2 represent a convolution kernel element in the third row and the third column.

Based on the coordinate in horizontal dimension Cx of the expanded matrix and the convolution kernel element coordinates RS, the second tensor of any one or more columns, that is, the coverage data in the first tensor corresponding to any one or more elements of the convolution kernel, can be located in the expanded matrix.

For example, Cx=0, R=0, and S=0 represent the first column in the expanded matrix, that is, the coverage data in first tensor corresponding to the element at the first row and the first column of the convolution kernel after multiple (e.g., 12) times of sliding. Cx=0, R=0, and S=1 represent the second column in the expanded matrix, that is, the coverage data in first tensor corresponding to the element at the first row and the second column of the convolution kernel after multiple (e.g., 12) times of sliding. In this manner, Cx=1, R=2, and S=2 represent the eighteenth column (the last column) in the expanded matrix, that is, the coverage data in first tensor corresponding to the element at the third row and the third column of the convolution kernel after multiple (e.g., 12) times of sliding.

For a second tensor located in any one or more columns of the expanded matrix, based on the mapping relationship between the expanded matrix and the first tensor, the multiple elements in the first tensor corresponding to second tensor can be determined, and the address information of those multiple elements in the first tensor corresponding to the second tensor can be determined as the address information of the second tensor.

For example, assuming that the second tensor is the first column [0 1 4 5 8 9 40 41 44 45 48 49] of expanded matrix, which corresponds to coverage data in the first tensor for the element at the first row and the first column of the convolution kernel, based on the mapping relationship between the expanded matrix and the first tensor, elements having the same marks as those of elements in the first column of the expanded matrix may be obtained from the first tensor, and addresses of elements [0 1 4 5 8 9 40 41 44 45 48 49] in the first tensor are determined as the address information of the second tensor.

For another example, assuming that the second tensor is the second column [1 2 5 6 9 10 41 42 45 46 49 50] of expanded matrix, which corresponds to coverage data in the first tensor for the element at the first row and the second column of the convolution kernel, based on the mapping relationship between the expanded matrix and the first tensor, elements having the same marks as those for elements in the second column of expanded matrix may be obtained from the first tensor, and addresses of elements [1 2 5 6 9 10 41 42 45 46 49 50] in the first tensor are determined as the address information of the second tensor.

In practical applications, the above process may be encapsulated as an instruction “TensorMemoryEngine”, which can be used to access one or more columns of the expanded matrix (corresponding to elements of the first tensor covered by one or more convolution kernel elements). This facilitates the tensor memory engine to access, from the global memory, with a single instruction, coverage data in the first tensor, which occupies a relatively large space, corresponding to any one or more convolution kernel elements. The pseudocode is as follows:
for t in range (T): \\represents that the coordinate in time dimension t of the convolution kernel, which is not shown in FIG. 5, is looped from 1 to T;
   for r in range (R): \\represents that the coordinate in vertical dimension r of the convolution kernel is looped from 1 to R;
      for s in range(S): \\represents that the coordinate in horizontal dimension s of the convolution kernel is looped from 1 to S;
         TensorMemoryEngine (tensor_info, conv_info, output_pos, (t, r, s)); \\“tensor_info” represents the tensor information of first tensor, “conv_info” represents the description information, “output_pos” represents the expanded matrix coordinate NPQCx, and (t, r, s) represents the convolution kernel coordinate RS.

In this way, the tensor storage engine may not execute the process of expanding the first tensor into an expanded matrix, thus needs not to occupy a large amount of storage space for recording the expanded matrix of the first tensor. In a scenario in which the expanded matrix is not obtained, the tensor storage engine may calculate, based on the expanded matrix coordinate NPQCx and the convolution kernel element coordinate RS, the coordinates of any element of the expanded matrix in the first tensor (for example, the coordinates of element of first tensor covered by one or more convolution kernel elements). This facilitates simplifying implementation logic of software by using a small amount of hardware resources (for example, the software implementing a convolution operation and a deconvolution operation).

In this way, based on the tensor information of the first tensor and the access information of a second tensor to be accessed (for example, expanded matrix coordinate, convolution kernel element coordinate), the tensor storage engine may quickly and accurately determine the address information of the second tensor (for example, coverage data in the first tensor corresponding to any one or more elements of the convolution kernel) from addresses of the first tensor.

In the data processing method of an embodiment of the present disclosure, the second tensor may be block data of the first tensor, or coverage data in the first tensor corresponding to any one or more elements of the convolution kernel, or data constituted by coverage data and constant value padding between individual elements in the coverage data. The data processing method can support block loading of the first tensor, block loading of expanded data suitable for convolution operation on the first tensor, and block loading of expanded data suitable for deconvolution operation on the first tensor, so as to unify multiple loading modes, which is more friendly to user programming.

In a possible implementation, the tensor information of the first tensor is stored in the global memory and the access information of the second tensor to be accessed is stored in a register.

Because the tensor information of the first tensor includes a large amount of content, and the tensor information of the first tensor would not be easily changed, the tensor information of the first tensor may be stored in the global memory. Because the second tensor to be accessed is the block data of any region in the first tensor, or the second tensor to be accessed is the coverage data in the first tensor corresponding to any one or more elements of the convolution kernel, the access information of the second tensor is variable, and the access information of the second tensor may be stored in a register for easy change during running of program.

Such a manner of storing invariant tensor information of the first tensor in a global memory and storing variable access information of the second tensor to be accessed in a register puts, depending on whether the information is easy to change, various types of information respectively at different places, which facilitates the improvement of flexibility and processing efficiency of data processing.

As a comparison, in synchronized memory access methods in the related arts, data needs to be loaded into a register bank; for example, for a general-purpose computing on graphics processing units (GPGPU) single instruction multiple thread (SIMT) architecture, registers for individual threads are isolated from one another and cannot be shared; data further needs to be migrated from the register to a shared storage space. In embodiments of the present disclosure, since the tensor storage engine is connected to a register that stores the access information of second tensor, the tensor storage engine may access the register at any time, so that multiple threads corresponding to the tensor storage engine can share the register. In addition, the processing method in embodiments of the present disclosure may employ a manner of register transfer for improving the flexibility of data processing.

In step S11, the address information of the second tensor is determined. In step S12, the second tensor may be read, based on the address information of the second tensor, from a global memory storing the first tensor to a local memory. The local memory is closer to the tensor storage engine than the global memory, and a read/write operation on the local memory by the tensor storage engine may be more efficiency. The tensor storage engine may perform data migration processing on the first tensor stored in the global memory, and store a second tensor determined based on the first tensor to a local memory corresponding to the tensor storage engine.

In a possible implementation, step S12 may include: in the case where a size of the second tensor is greater than a read bandwidth, based on the address information of the second tensor, splitting a first memory access request for reading the second tensor from the global memory to the local memory into a plurality of second memory access requests, wherein each second memory access request is used to read split data of a different part of the second tensor from the global memory to the local memory; and based on the plurality of second memory access requests, writing serially a plurality of split data in the global memory that constitute the second tensor into a local memory. The read bandwidth refers to the ability of reading data from a memory within a time unit; the read bandwidth of a memory may be represented by bits or bytes transmitted each time.

For example, assuming that the read bandwidth of the global memory is 128 bytes, a second tensor to be accessed by the first memory access request has 1024 bits, its corresponding address is 0, and the read bandwidth supports a maximum memory access request of 128 bits, then the first memory access request may be split into eight second memory access requests, that is, second memory access request 0 to second memory access request 7, wherein the second memory access request 0 is used for reading, from the address 0 in the global memory, split data 0 of 128 bits belonging to the second tensor to the local memory; the second memory access request 1 is used for reading, from the address 128 in the global memory, split data 1 of 128 bits belonging to the second tensor to the local memory; the second memory access request 2 is used for reading, from the address 256 in the global memory, split data 2 of 128 bits belonging to the second tensor to the local memory; the second memory access request 3 is used for reading, from the address 384 in the global memory, split data 3 of 128 bits belonging to the second tensor to the local memory; the second memory access request 4 is used for reading, from the address 512 in the global memory, split data 4 of 128 bits belonging to the second tensor to the local memory; the second memory access request 5 is used for reading, from the address 640 in the global memory, split data 5 of 128 bits belonging to the second tensor to the local memory; the second memory access request 6 is used for reading, from the address 768 in the global memory, split data 6 of 128 bits belonging to the second tensor to the local memory; and the second memory access request 7 is used for reading, from the address 896 in the global memory, split data 7 of 128 bits belonging to the second tensor to the local memory. Then, the split data 0 to split data 7 in the global memory constituting the second tensor may be serially written into the local memory based on the second memory access request 0 to the second memory access request 7. It should be understood that the size of the second tensor and the size of the read bandwidth are not specifically limited in present disclosure, which may be set according to an actual application scenario.

In this way, if the size of the second tensor in the global memory exceeds a maximum granularity supported by the storage system, splitting can be performed for serial processing, improving the applicability of the data processing method according to embodiments of the present disclosure. In addition, in the embodiments of the present disclosure, the read bandwidth of the global memory is less than that of the local memory. Data (for example, the second tensor) is read from the global memory to the local memory, and the local memory can be reused multiple times, for reducing the pressure on the bandwidth of the global memory.

In step S12, the second tensor is read from a global memory storing the first tensor to a local memory. In step S13, in response to the local memory receiving the second tensor, an interrupt may be triggered. In step S12, the tensor storage engine performs a migration process on the second tensor from the global memory to the local memory, which may consume a relatively long time. While waiting for the local memory to receive the second tensor and trigger an interrupt, the tensor storage engine can asynchronously execute other instructions, so as to further improve processing efficiency.

In this way, by setting an interrupt-wake-up mechanism, instead of a pipeline approach (e.g., executing the next instruction only when data has been migrated to a destination), other instructions may be executed after the current instruction is sent out, and a completion of the current instruction is waited for, so as to send a signal to the processor core for triggering an interrupt, waking up the current instruction, which results in higher efficiency.

In the data processing method according to the embodiment of the present disclosure, based on the tensor information of the first tensor and the access information of the second tensor to be accessed, the second tensor may be quickly read from the global memory storing the first tensor to the local memory, improving the efficiency and flexibility of tensor storage. Further, one interrupt is triggered whenever the local memory receives the second tensor once, achieving asynchrony in a tensor reading process.

The second tensor of an embodiment of the present disclosure may be block data of the first tensor, or coverage data in the first tensor corresponding to any one or more elements of the convolution kernel, or data constituted by coverage data and constant value padding between individual elements in the coverage data. Block loading of the first tensor, block loading of expanded data suitable for convolution operation on the first tensor, and block loading of expanded data suitable for deconvolution operation on the first tensor can be supported, so as to unify multiple loading modes, which is more friendly to user programming.

According to the processing method of an embodiment of the present disclosure, invariant tensor information of first tensor may be stored in a global memory and variable access information of second tensor to be accessed may be stored in a register. Depending on whether the information is easy to change, various types of information are respectively put at different places, which facilitates the improvement of flexibility and processing efficiency of data processing.

It can be understood that each of the foregoing method embodiments in the present disclosure can be combined with each other to form a combined embodiment without departing from the principle and logic, which will not be redundantly described herein due to length limitation. Those skilled in the art may understand that, in the foregoing method in the specific implementations, the specific execution order of respective steps should be determined based on functions and possible internal logic thereof.

In addition, the present disclosure further provides a data processing apparatus, an electronic device, a computer readable storage medium, and a program. All of them may be used to implement any one of the data processing methods provided by the present disclosure. The corresponding technical solutions and descriptions can be referred to in the corresponding descriptions on the method part, which will not be redundantly described herein.

FIG. 6 shows a block diagram of a data processing apparatus according to an embodiment of the present disclosure. As shown in FIG. 6, the apparatus comprises:
a determining module 61, configured to determine, based on tensor information of a first tensor and access information of a second tensor to be accessed, address information of the second tensor;
a reading module 62, configured to read, based on the address information of the second tensor, the second tensor from a global memory storing the first tensor to a local memory; and
a trigger module 63, configured to trigger an interrupt in response to the local memory receiving the second tensor.

In a possible implementation, the determining module 61 is configured to determine, in the case where the second tensor to be accessed is a block data of the first tensor, and the access information comprises a position of the second tensor in the first tensor and a size of the second tensor, the address information of the second tensor from addresses of the first tensor based on the tensor information of the first tensor, the position of the second tensor in the first tensor, and the size of the second tensor.

In a possible implementation, the determining module 61 is further configured to: perform, based on the tensor information of the first tensor and the access information of the second tensor to be accessed, boundary checking on the second tensor, to obtain a checking result for the second tensor; and in the case where the checking result indicates that the first part of the second tensor is located inside the first tensor and a second part of the second tensor is located outside the first tensor, determine, based on the tensor information of the first tensor and the access information of the second tensor, address information of a first part of the second tensor; and the reading module 62 is configured to read, in the case where the tensor information of the first tensor includes padding identifiers, the first part of the second tensor from a global memory storing the first tensor to a local memory based on the address information of the first part of the second tensor; pad, based on the padding identifier, the second part of the second tensor, to obtain the second part of the second tensor; and write the second part of the second tensor into the local memory.

In a possible implementation, the determining module 61 is configured to obtain, in the case where the second tensor to be accessed is coverage data in the first tensor corresponding to any one or more elements in a convolution kernel, and the access information comprises an expanded matrix coordinate and a convolution kernel element coordinate, a mapping relationship between the expanded matrix and the first tensor; and determine, based on the tensor information of the first tensor, the mapping relationship, the expanded matrix coordinate, and the convolution kernel element coordinate, the address information of the second tensor from addresses of the first tensor, wherein the expanded matrix is a matrix that is arranged in rows or columns by sequentially converting, in the first tensor, the coverage data corresponding to a receptive field of the convolution kernel into corresponding column vectors or row vectors based on the description information, and the description information comprising convolution description information and deconvolution description information.

In a possible implementation, determining, based on the tensor information of the first tensor, the mapping relationship, the expanded matrix coordinate, and the convolution kernel element coordinate, the address information of the second tensor from addresses of the first tensor, comprising: determining, based on the expanded matrix coordinate and the convolution kernel element coordinate, the second tensor to be accessed from the expanded matrix; determining, based on the mapping relationship between the expanded matrix and the first tensor, a plurality of elements in the first tensor corresponding to the second tensor; and determining address information of the plurality of elements in the first tensor corresponding to the second tensor as the address information of the second tensor.

In a possible implementation, the reading module 62 is configured to: split, in the case where the size of the second tensor is greater than a read bandwidth, a first memory access request for reading the second tensor from the global memory to the local memory into a plurality of second memory access requests based on the address information of the second tensor, wherein each second memory access request is used to read split data of a different part of the second tensor from the global memory to the local memory; and based on the plurality of second memory access requests, write serially a plurality of split data in the global memory that constitute the second tensor into a local memory.

In a possible implementation, the tensor information of the first tensor is stored in the global memory and the access information of the second tensor to be accessed is stored in a register.

In a possible implementation, the first tensor comprises feature data in a deep learning task, and the feature data comprises at least one of image feature data, speech feature data, or text feature data.

The method has a specific technical association with the internal structure of the computer system, and can solve the technical problem of how to improve hardware computing efficiency or execution effect (including reducing data storage amount, reducing data transmission amount, improving hardware processing speed, etc.), thereby achieving the technical effect of improving the internal performance of the computer system, complying with natural laws.

In some embodiments, the functions of or the modules included in the apparatus provided in the embodiments of the present disclosure may be used to carry out the methods described in the above method embodiments, the specific implementation of which may refer to the description of the above method embodiments and will not be repeated herein for the sake of brevity.

An embodiment of the present disclosure further provides a computer readable storage medium having computer program instructions stored thereon. The computer program instructions, when executed by a processor, implement the above method. The computer readable storage medium may be a transitory or non-transitory computer readable storage medium.

An embodiment of the present disclosure further provides an electronic device. The electronic device includes: a processor; and a memory for storing instructions executable by the processor, wherein the processor is configured to invoke the instructions stored in the memory to implement the above method.

An embodiment of the present disclosure further provides a computer program product comprising a computer readable code or a non-transitory computer readable storage medium carrying the computer readable code. When the computer readable code runs in a processor of the electronic device, the processor in the electronic device implements the above method.

The above computer program product may be implemented in a specific manner by hardware, software, or a combination thereof. In an optional embodiment, the computer program product is specifically embodied as a computer storage medium. In another optional embodiment, the computer program product is specifically embodied as a software product, such as a Software Development Kit (SDK).

Embodiments of the present disclosure further provide an electronic device, which may be provided as a terminal, a server or a device in another form, for example, a user equipment (UE), a mobile device, a user terminal, a terminal, a cellular phone, a cordless telephone, a personal digital assistant (PDA), a handheld device, a computing device, an in-vehicle device, a wearable device, and the likes.

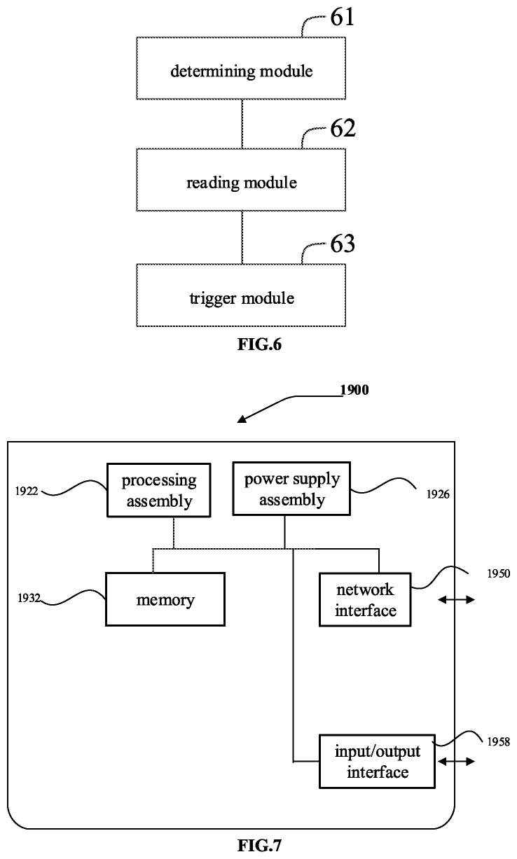

FIG. 7 shows a block diagram of an electronic device 1900 according to an embodiment of the present disclosure. For example, the electronic device 1900 may be provided as a server or a terminal device. Referring to FIG. 7, the electronic device 1900 includes a processing assembly 1922 which further comprises one or more processors, and a memory resource represented by a memory 1932 for storing instructions executable by the processing assembly 1922, such as application program. The application program stored in the memory 1932 may include one or more modules, each corresponding to a set of instructions. In addition, the processing assembly 1922 is configured to execute instructions to carry out the above method.

The electronic device 1900 may further include a power supply assembly 1926 configured to carry out the power management of the electronic device 1900, a wired or wireless network interface 1950 configured to connect the electronic device 1900 to a network, and an input/output interface 1958. The electronic device 1900 may operate based on an operating system stored in the memory 1932, such as a Microsoft server operating system (Windows Server™), a graphical user interface-based operating system launched by Apple Inc. (Mac OS X™), a multi-user and multi-process computer operating system (Unix™), a free and open source code Unix-like operating system (Linux™), an open source code Unix-like operating system (FreeBSD™), or the likes.

In an exemplary embodiment there is further provided a non-transitory computer readable storage medium, such as the memory 1932 that includes computer program instructions. The computer program instructions may be executed by the processing assembly 1922 of the electronic device 1900 to implement the above methods.

The present disclosure may be a system, a method, and/or a computer program product. The computer program product may include a computer readable storage medium carrying computer readable program instructions for causing a processor to implement the aspects of the present disclosure.

The computer readable storage medium can be a tangible device that can retain and store instructions used by an instruction executing device. The computer readable storage medium may be, but not limited to, e.g., electronic storage device, magnetic storage device, optical storage device, electromagnetic storage device, semiconductor storage device, or any proper combination thereof. More specific examples (a non-exhaustive list) of the computer readable storage medium include: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions stored thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing devices from a computer readable storage medium or to an external computer or external storage device via network, for example, the Internet, local area network, wide area network, and/or wireless network. The network may comprise copper transmission cables, optical fiber transmission, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium in the respective computing/processing devices.

Computer program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++, and the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the case with remote computer, the remote computer may be connected to the user's computer through any type of network, including local area network (LAN) or wide area network (WAN), or may be connected to an external computer (for example, connected through the Internet from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to implement the aspects of the present disclosure.

Aspects of the present disclosure have been described herein with reference to the flowchart and/or the block diagrams of the method, apparatus (system), and computer program product according to the embodiments of the present disclosure. It should be understood that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing apparatuses, to produce a machine, such that the instructions produce means for implementing the functions/acts specified in one or more blocks in the flowchart and/or block diagram when executed by the processor of the computer or other programmable data processing apparatuses. These computer readable program instructions may also be stored in a computer readable storage medium, wherein the instructions cause a computer, a programmable data processing apparatus, and/or other devices to work in a particular manner, such that the computer readable storage medium having instructions stored thereon comprises a product that includes instructions implementing aspects of the functions/acts specified in one or more blocks in the flowchart and/or block diagram.

The computer readable program instructions may also be loaded onto a computer, other programmable data processing apparatuses, or other devices to have a series of operational steps executed on the computer, other programmable apparatuses or other devices, so as to produce computer implemented processes, such that the instructions executed on the computer, other programmable data processing apparatuses, or other devices implement the functions/acts specified in one or more blocks in the flowchart and/or block diagram.

The flowcharts and block diagrams in the drawings illustrate the systematic architectures, functions, and operations that may be implemented by the system, method and computer program product according to the various embodiments of the present disclosure. In this regard, each block in the flowchart or block diagram may represent a module, a program segment, or a part of instructions, which comprises one or more executable instructions for implementing the specified logical functions. In some alternative implementations, the functions denoted in the blocks may occur in an order different from that denoted in the drawings. For example, two contiguous blocks may, in fact, be executed substantially parallel, or sometimes they may be executed in a reversed order, depending upon the functions involved. It will also be noted that each block in the block diagram and/or flowchart, and combinations of blocks in the block diagram and/or flowchart, can be implemented by dedicated hardware-based systems executing the specified functions or acts, or by combinations of dedicated hardware and computer instructions.

The computer program product may be implemented in a specific manner by hardware, software or a combination thereof. In an optional embodiment, the computer program product is specifically embodied as a computer storage medium. In another optional embodiment, the computer program product is specifically embodied as a software product, such as a Software Development Kit (SDK).

The foregoing descriptions of the embodiments tend to emphasize differences between the embodiments, while the same or similar parts may be referred to each other, which are not redundantly described herein for brevity.

Those skilled in the art may understand that, in the foregoing method in the specific implementation, the drafted order of respective steps does not mean a strict order of execution constituting any limit to an implementation process, the specific order of execution for respective steps should be determined based on functions and possible internal logic thereof.

Although the embodiments of the present disclosure have been described above, the above descriptions are merely exemplary, but not exhaustive; and the disclosed embodiments are not limiting. A number of variations and modifications may apparently occur to those of ordinary skill in the art without departing from the scopes and spirits of the described embodiments. The terms used in the present disclosure are selected to provide the best explanation on the principles and practical applications of the embodiments or the technical improvements to the arts on market, or to make the embodiments described herein understandable to those of ordinary skill in the art.

What is claimed is:

1. A data processing method, comprising:
determining, based on tensor information of a first tensor and access information of a second tensor to be accessed, address information of the second tensor, wherein the second tensor includes any one of: block data of the first tensor, coverage data in the first tensor corresponding to any one or more elements of convolution kernel, data constituted by coverage data and constant value padding between individual elements in the coverage data, the tensor information of the first tensor includes data structure information of the first tensor and address information of the first tensor;
reading, based on the address information of the second tensor, the second tensor from a global memory storing the first tensor to a local memory; and
triggering an interrupt in response to the local memory receiving the second tensor.

2. The method according to claim 1, wherein in a case where the second tensor to be accessed is a block data of the first tensor, the access information comprises: a position of the second tensor in the first tensor; and a size of the second tensor,
determining, based on tensor information of a first tensor and access information of a second tensor to be accessed, address information of the second tensor, comprising:
determining, based on the tensor information of the first tensor, the position of the second tensor in the first tensor, and the size of the second tensor, the address information of the second tensor from addresses of the first tensor.

3. The method according to claim 2, further comprising:
performing, based on the tensor information of the first tensor and the access information of the second tensor to be accessed, boundary checking on the second tensor, to obtain a checking result for the second tensor; and
in a case where the checking result indicates that a first part of the second tensor is located inside the first tensor and a second part of the second tensor is located outside the first tensor, determining, based on the tensor information of the first tensor and the access information of the second tensor, address information of the first part of the second tensor,
wherein the tensor information of the first tensor includes padding identifiers, and reading, based on the address information of the second tensor, the second tensor from a global memory storing the first tensor to a local memory, comprising:
reading, based on the address information of the first part of the second tensor, the first part of the second tensor from the global memory storing the first tensor to the local memory;
padding, based on the padding identifier, the second part of the second tensor, to obtain the second part of the second tensor; and
writing the second part of the second tensor into the local memory.

4. The method according to claim 1, wherein in a case where the second tensor to be accessed is coverage data in the first tensor corresponding to any one or more elements in a convolution kernel, the access information comprises: an expanded matrix coordinate and a convolution kernel element coordinate, the expanded matrix being a matrix that is arranged in rows or columns by sequentially converting, in the first tensor, the coverage data corresponding to a receptive field of the convolution kernel into corresponding column vectors or row vectors based on description information, the description information comprising convolution description information and deconvolution description information, and
determining, based on tensor information of a first tensor and access information of a second tensor to be accessed, address information of the second tensor, comprising:
obtaining a mapping relationship between the expanded matrix and the first tensor; and
determining, based on the tensor information of the first tensor, the mapping relationship, the expanded matrix coordinate, and the convolution kernel element coordinate, the address information of the second tensor from addresses of the first tensor.

5. The method according to claim 4, wherein determining, based on the tensor information of the first tensor, the mapping relationship, the expanded matrix coordinate, and the convolution kernel element coordinate, the address information of the second tensor from addresses of the first tensor, comprising:
determining, based on the expanded matrix coordinate and the convolution kernel element coordinate, the second tensor to be accessed from the expanded matrix;
determining, based on the mapping relationship between the expanded matrix and the first tensor, a plurality of elements in the first tensor corresponding to the second tensor; and
determining address information of the plurality of elements in the first tensor corresponding to the second tensor as the address information of the second tensor.

6. The method according to claim 1, wherein reading, based on address information of the second tensor, the second tensor from a global memory storing the first tensor to a local memory, comprising:
in a case where a size of the second tensor is greater than a read bandwidth, based on the address information of the second tensor, splitting a first memory access request for reading the second tensor from the global memory to the local memory into a plurality of second memory access requests, wherein each second memory access request is used to read split data of a different part of the second tensor from the global memory to the local memory; and
based on the plurality of second memory access requests, writing serially a plurality of split data in the global memory that constitute the second tensor into the local memory.

7. The method according to claim 1, wherein the tensor information of the first tensor is stored in the global memory and the access information of the second tensor to be accessed is stored in a register.

8. The method according to claim 1, wherein the first tensor comprises feature data in a deep learning task, and the feature data comprises at least one of image feature data, speech feature data, or text feature data.

9. An electronic device, comprising: a processor; and
a memory, the memory stores computer readable instructions, and the computer readable instructions, when executed by the processor, cause the processor to:
determine, based on tensor information of a first tensor and access information of a second tensor to be accessed, address information of the second tensor, wherein the second tensor includes any one of: block data of the first tensor, coverage data in the first tensor corresponding to any one or more elements of convolution kernel, data constituted by coverage data and constant value padding between individual elements in the coverage data, the tensor information of the first tensor includes data structure information of the first tensor and address information of the first tensor;
read, based on the address information of the second tensor, the second tensor from a global memory storing the first tensor to a local memory; and
trigger an interrupt in response to the local memory receiving the second tensor.

10. A non-transitory computer program product, comprising a computer readable code or a computer readable storage medium carrying the computer readable code, wherein when the computer readable code runs in a processor of an electronic device, the processor in the electronic device is configured to:
determine, based on tensor information of a first tensor and access information of a second tensor to be accessed, address information of the second tensor, wherein the second tensor includes any one of: block data of the first tensor, coverage data in the first tensor corresponding to any one or more elements of convolution kernel, data constituted by coverage data and constant value padding between individual elements in the coverage data, the tensor information of the first tensor includes data structure information of the first tensor and address information of the first tensor;
read, based on the address information of the second tensor, the second tensor from a global memory storing the first tensor to a local memory; and
trigger an interrupt in response to the local memory receiving the second tensor.
